(19) United States
(12) Patent Application Publication
(10) Pub. No.: US 2008/0200849 A1
(43) Pub. Date: Aug. 21, 2008

(54) Body Massager with Learning Capability

(76) Inventors: Geoffrey Hollington, Lewes (GB); Duncan Turner, Chorleywood (GB); Christopher Glaister, London (GB)

Correspondence Address: WELSH & FLAXMAN LLC, 2000 DUKE STREET, SUITE 100, ALEXANDRIA, VA, 22314, US

(21) Appl. No.: 12/024,420

(22) Filed: Feb. 1, 2008

(30) Foreign Application Priority Data
Feb. 5, 2007 (EP) 07101749.5

(51) Int. Cl. A61H 7/00; A61H 1/00; A61H 15/00

(52) U.S. Cl. 601/46; 601/134; 601/131

(57) ABSTRACT

A body massager comprises a housing having a membrane attached thereto. A ball is moveably retained within a cup, the ball engaging with and moveable along an inner surface of the membrane. A drive means drives the cup and ball across the inner surface of the membrane.

### CROSS REFERENCE TO RELATED APPLICATION

This application claims the benefit of European Patent Application No. 07101749.5, filed Feb. 5, 2007, entitled “BODY MASSAGER WITH LEARNING CAPABILITY”.

The present invention relates to a body massager with the capability to learn a user's preferences.

There are many types of currently known body massagers which aim to produce pleasant, stress-relieving sensations when applied to the body. Body massagers with electrically powered motors are available so that movement such as vibration can be produced to improve the quality of massaging without increasing effort required by the user.

Some motorised body massagers have several different settings, for example, the choice of several different vibration frequencies. However, the options a user has to choose from are very limited and massagers do not normally offer programmable variation in the motion characteristics of the massager during the course of a massage session. In particular, there are difficulties associated with providing complex motion of the massaging elements in a controllable manner.

Furthermore, the problems with providing a massager which is capable of complex massage motions are compounded due to the conflicting requirements of such a massager. The massager preferably should be usable without being connected to an external device, so the moving parts must be self-powered. However, the overall arrangement of parts must be safe and secure so that the massager is safe and comfortable to use on the body, for example the massager must not trap skin or hair. Furthermore, the moving parts necessary can be vulnerable to damage and must be arranged in such a way that possibility of damage is minimised. Additionally the arrangement of parts must be simple so that the massager is simple for a user to operate and clean. Finally, there is the problem of the mechanism driving the moving parts extending well beyond the boundaries of the moving parts themselves and so causing the massager to be undesirably bulky.

The present invention aims to overcome these limitations of conventional body massagers and aims to provide a body massager with a high degree of programmability, movement variation, and user control. The present invention provides a massager which enables the required motions to take place and has a safe, secure, simple and compact mechanical design. In particular, the present invention provides a massager which is capable of controllable complex motion.

According to the present invention there is provided a body massager comprising a housing having a membrane attached thereto; a ball moveably retained within a cup, the ball engaging with and moveable along an inner surface of the membrane; and a drive means for driving the cup and ball across the inner surface of the membrane.

The arrangement of the massaging element comprising a ball retained within a cup provides for maintenance free, low friction movement of a massage element, which does not require lubrication. This has the benefit of reducing wear and tear on the membrane such as that caused by stretching, or the massaging element catching against the membrane, which will prolong the lifespan of the membrane. For example if, when moving the ball along an inner surface of the membrane, the ball were to stop moving in it's cup, then it is quite likely that it would catch on the inner surface of the membrane, causing it to stretch locally, which could lead to it tearing.

The membrane itself ensures that the inner workings of the body massager are impervious to liquid, whilst providing a smooth massaging surface.

According to the present invention there is also provided a control system for controlling the movement of a massage element in a body massager which learns a user's preferred movements, the system comprising a drive means for driving the movement of the massage element; a controller for controlling the movement of the massage element via the drive means; a position sensor for sensing the position of the massage element; a memory for storing the positions of the massage element; and input means for allowing a user to either repeat or progress a sequence of movements performed by the massage element, wherein the controller is arranged such that different sequences of movements are generated by the controller and then performed by the massage element and a score is recorded in the memory for that particular sequence of movements based upon the user's input, and such that the score is used by the controller to determine the frequency of use of such particular sequence.

A body massager with the ability to learn which movements are preferred by a user provides for the device to be entirely self-contained. As all movements are randomly generated by a microprocessor, a user will not get bored with or by a limited number of movements being performed repeatedly. There is always the possibility of new and different movements being included in a sequence, and the user can then pick and choose which they like or dislike.

An example of a body massager according to the present invention will now be described in detail with reference to the accompanying drawings, in which:

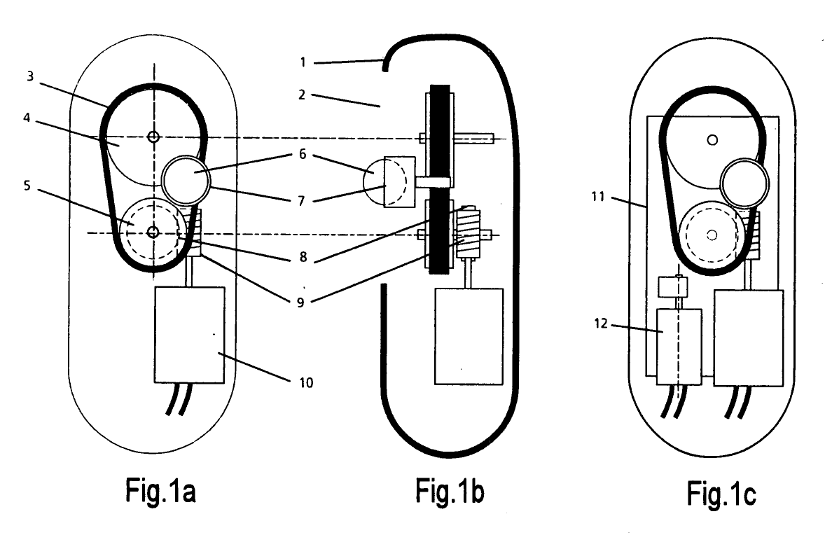

FIG. 1A shows a perspective view of a body massager according to an example of the present invention;

FIG. 1B shows a side perspective view of a body massager according to an example of the present invention;

FIG. 1C shows a perspective view of a body massager according to an example of the present invention with a vibration frame and motor included.

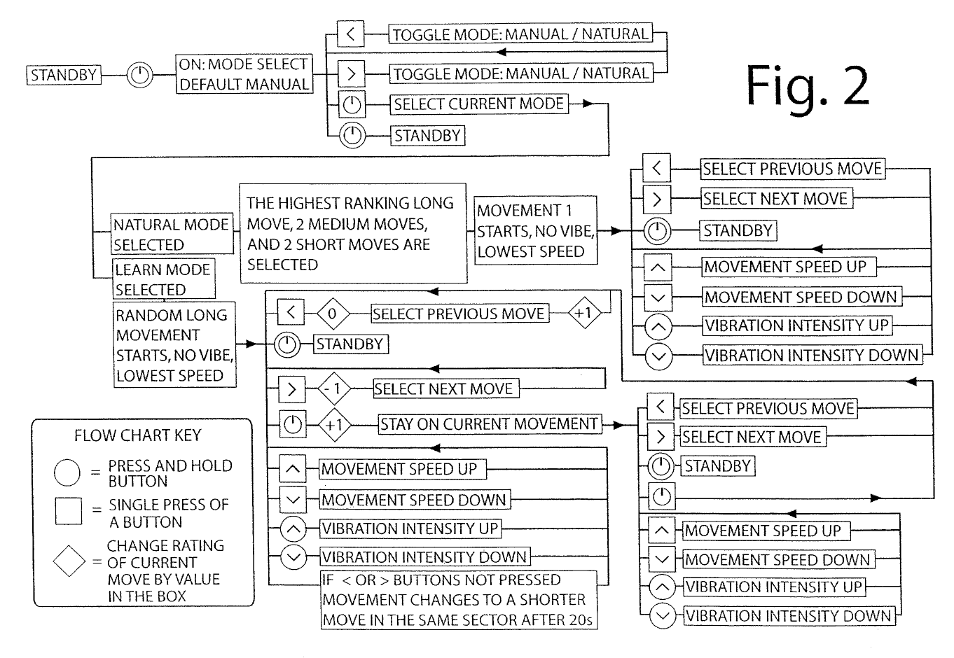

FIG. 2 is a flow diagram showing an example of a microprocessor learning process and the key steps involved;

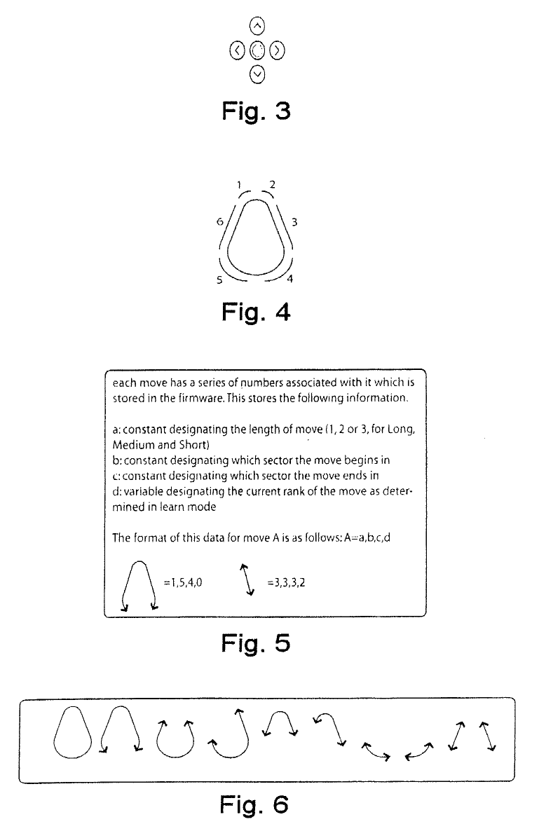

FIG. 3 shows an example button layout on the massager;

FIG. 4 shows an example of how the trajectory of the massaging element can be split into different sectors;

FIG. 5 show an example of how the information for different movements can be stored in a memory;

FIG. 6 shows examples of different movements around an oval trajectory;

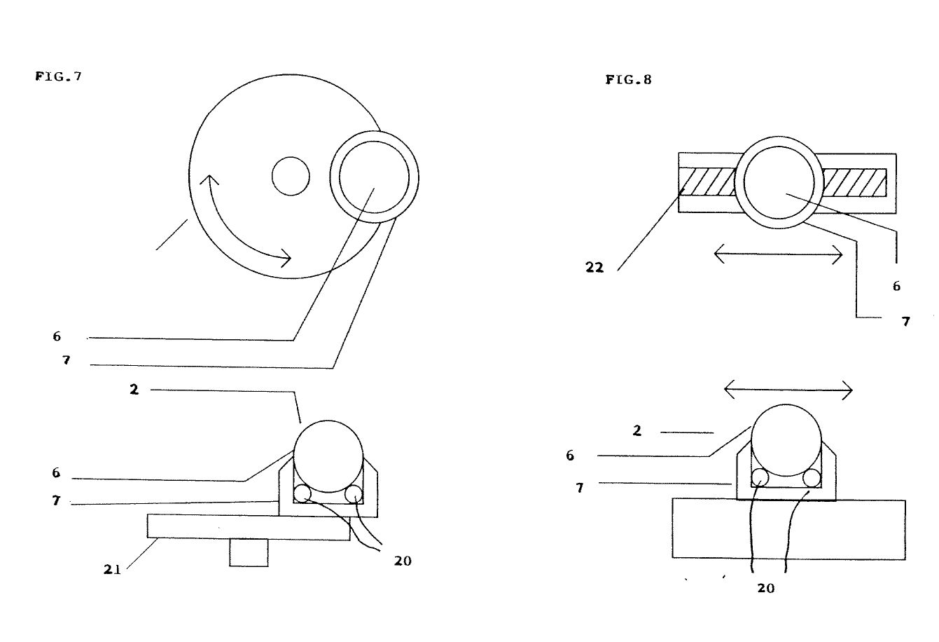

FIG. 7 shows an example alternative drive mechanism that may be employed by the present invention; and

FIG. 8 shows a further alternative mechanism that may be employed by the present invention.

Referring to FIGS. 1A and 1B, the body massager has a housing 1, which encases a massaging element 7 comprising a ball 6 retained within a cup, two pulleys 4, 5 and a belt 3. The belt 3 is arranged to move the massaging element 7 underneath an elastomeric membrane 2, which covers an opening in the housing 1, and an electric motor 10 for providing driving means to the massaging element 7 via a worm gear 9. The opening in the housing 1 is arranged to be positioned above the massaging element 7 and to span the area across which the massaging element 7 moves.

The housing 1 may be made of a plastics material and is ergonomically shaped and designed to be held in one hand while the massaging element 7 is applied to the body. In this example, the housing 1 is constructed from two halves which are moulded separately and then joined together.

FIG. 1B shows the membrane 2 spanning the opening in the housing 1. In this example the membrane 2 is continuous, elastic and extends up and around the edges of the housing 1 on all sides, thus covering the join between the two housing halves and preventing the ingress of liquids.

The housing 1 may be compatible with different interchangeable membranes, each with different textures so that a user could enjoy the feel of different “skins”, for example, membranes with ridges, or bumps on the outer surface, under which the massaging element 7 travels.

Various control buttons are provided in the housing 1. In this example the control buttons are on arranged to be on the opposite side of the housing 1 to the massaging element 7, they are constructed from a combination of hard and flexible plastics material, and are moulded integrally to the housing 1 so that no liquid can enter around them. FIG. 3 shows an example button layout which could be used on the body massager.

The controller in this example is a circuit incorporating a microprocessor (not shown) situated inside the housing 1. Referring to FIG. 1A, the massaging element 7 is driven by an electric motor 10, which in this example is a stepper motor. The motor 10 is able to turn both clockwise and counterclockwise and can induce in the output shaft rotation in accurate angular segments at controlled speeds and accelerations.

To enable the massaging element 7 to move in predictable, repeatable patterns, it is preferable for information on the position of the massage element 7 to be fed back to the microprocessor. This is achieved in this example by fitting optical encoders to the mechanism, consisting of striped discs, or markers, and optical sensors. In this example two optical encoders are used, although they are not shown in the figures.

The movement park position and movement position of the massaging element 7 are read and fed back to the microprocessor by sensors and an encoder disc, or marker, attached to the drive system. This is, of course, only one method of providing positional information to the microprocessor, there are many other methods of providing a similar function.

In this example a wheel 5 is connected to the electric motor 10 by a worm gear 9 attached to the output shaft of the electric motor 10. The motor 10 is driven by the microprocessor, which provides movement instructions, which cause the electric motor 10 to drive the belt 3 and thus the massaging element 7 in complete or partial portions of it's trajectory, either clockwise or counterclockwise, at various speeds. This creates the massaging movement of the massaging element 7 under the membrane 2.

The massaging element 7 moves along the inner surface of the membrane 2. In this example, the massaging element 7 is moved in an X-Y plane substantially parallel to the covering membrane 2 by a toothed belt 3 looped around two toothed wheels of dissimilar diameter 4, 5 in an ‘egg’ shaped, oval trajectory. The trajectory will be referred to from here on as the track and the arrangement of belt 3 and wheels 4, 5 will be referred to from here on as the drive means.

There are other possible drive means, which could be employed. For example a drive means could comprise a flat belt, or a chain, and could include several massaging elements either grouped together or spread out along the belt. The drive means could also comprise more than two wheels, thereby describing a different shaped track.

FIGS. 7 and 8 show two alternatives. In FIG. 7 a ball 6 and cup 7 is still provided below a membrane 2. Additional supporting bearings 20 are also provided to ensure smooth movement of the ball 6 in the cup 7. In the example of FIG. 7 the drive mechanism is simplified in that the cup is positioned on a rotating disk 21 to provided a simply rotary motion for the cup 7 and ball 6. It will be appreciated that such a disk could be used in conjunction with other components to provide something other than a simple rotary motion if required. FIG. 8 shows a further alternative in which the cup 6 and ball 7 is still placed beneath a membrane 2, but is supported on a worm screw 22 which is driven to provide linear motion for the ball and cup 6, 7. Again, such a drive mechanism could be used in combination with other mechanisms to provide more complex motions.

Vibration can also be provided to the massaging element 7. This may be provided either directly, such as by attaching a vibration device to the massaging element 7, or indirectly, as demonstrated in FIG. 1C.

In this example, vibration is provided to the massaging element by a revolving eccentric mass. This eccentric mass is attached to the shaft of an electric motor 12, which is in turn rigidly attached to a frame 11 mounted on flexible mountings inside the housing 1. The flexible mountings in this example are compliant rubber bushes. The drive means for the massaging element 7 are also attached to this frame 11. The massaging element 7 can therefore vibrate independent of the housing 1.

The vibration motor 12 is controlled by the microprocessor so that the massaging element 7 can be made to vibrate at various speeds to complement the massage motion. The vibration frequency may be in the range of 0-120 Hertz and the amplitude may be about 1 mm at the massaging element 7.

There are five buttons provided for the body massager in this example, as shown in FIG. 3. Two of the buttons control the massage element's movement, and are used to either progress or repeat a sequence of movements. Two of the buttons control movement speed and vibration speed; a single press increases or decreases movement speed, and if the same buttons are pressed and held down, the vibration intensity is increased or decreased. The fifth button has a number of features; it is primarily a power button, but can also be used for play/stop, pause/resume and to set/unset continuous mode, whereby a particular movement sequence is performed continuously.

The number of buttons provided on the housing can differ, and/or the buttons may perform different functions. The buttons could also be located elsewhere, for example on one of the sides of the housing 1, and could be manufactured separately to the housing 1.

The massager may be powered by rechargeable batteries, in which case there is also an opening in the housing 1 for an electrical socket on the housing 1 to receive a charger plug. The sockets may be sealed, for example with a flexible plug, again to prevent the ingress of liquids.

The mechanical components such as the wheels 4, 5 and frame 11 can be moulded from plastics materials such as nylon and may be self-lubricating, or, if the structure requires it, certain components may be metal.

The body massager receives no external instruction concerning the movement of the massaging element around the track; instead, all movement instructions are generated and then provided to the electric motors 10, 12 by the microprocessor inside the housing 1. The microprocessor is programmed to “learn” which movements a user likes and dislikes, the body massager thereby becoming personalised to each user.

The learning process described in the example of FIG. 2 will now be explained in more detail. Each time the massager is used, the microprocessor generates and provides instructions to the electric motor 10 for random, or pseudo random, movement sequences of the massaging element 7 via the drive means, which the user then decides whether they like or not. During a massage session the microprocessor changes the parameters of the motion relative to elapsed time; for example, if no instruction to change movement is received, the current movements of the massaging element 7 can become progressively shorter.

A user has the capability to intervene in this sequence, including control of the speed of motion and control of vibration. Therefore, at any time during a random movement, a user can override the progressive change by deciding either to move on to another random movement sequence or to go back to the previous random movement sequence.

A further feature could be for a body massager to progress onto the next random movement sequence according to elapsed time depending on whether or not there was manual input, or perhaps simply because a predetermined time had passed.

In the example shown in FIG. 2, a user selects either ‘natural’ or ‘manual’ mode. When ‘natural’ mode is selected, the highest ranking moves are selected, initially with no vibration and at the lowest speed. The user can then adjust these properties as desired.

If a user selects ‘manual’ mode, then the body massager enters the learning programme (learn mode). Random movements are made by the massaging element, initially with no vibration and at the lowest speed. It is for the user to refine these movements according to their personal preference, and the body massager will learn these preferences by allocating a score according to what was chosen. This is done using the buttons provided on the body massager. The body massager allocates a score (for example a numerical score) to each movement, which is stored in a memory to indicate the user's preferred movements, as follows.

A user can choose to repeat a previous movement, in which case the current movement is allocated a score of 0 and the previous movement is allocated a score of +1.

A user can choose to progress onto the next movement, in which case the current movement will be allocated a score of −1.

A user can choose to maintain the current movement, in which case that movement will be allocated a score of +1. A user then has all the options available to them once more.

In addition to these options, as mentioned previously, a user can, at any time, increase or decrease both the speed of the movement and the vibration.

If, however, a user does not press a button, the current movement will shorten after 20 seconds and, again, the user will have all the options available to them.

Of course, this is only one method by which a body massager can learn a user's preferences.

Another method of “learning” could be that for each time a user makes a decision about a movement sequence, or manually adjusts the speed of movement or vibration, the microprocessor allocates a score, or “popularity rating”, to that movement sequence and stores it in a memory. For example, a movement sequence which a user opted to move on from would score low, depending on how quickly the user moved on from it, whereas a movement sequence which a user opted to return to would score highly. A movement sequence that a user made no changes to would also be allocated a score.

Yet another method of “learning” could be that for every time the user makes a decision about a movement sequence, the microprocessor remembers the selected change and stores its description in memory. These memorised descriptions are given a popularity rating by the microprocessor; the more times a description is represented in memory the higher the rating.

As the microprocessor learns the user's preferred movements, it begins to include these more often in massage sequences rather than simply creating motions randomly each time a different movement is required. The microprocessor will continue to create and introduce random motions into massage sequences, but the more it “learns” the preferences of the user (that is to say the higher each movement scores), the more it will include preferred moves into a massage sequence.

FIGS. 4, 5 and 6 are examples of movements about an oval track, created by using two pulleys of dissimilar diameters.

FIG. 4 shows how a track can be split into different sectors, which can be numbered and then used by the microprocessor to describe movements, as explained in FIG. 5.

In FIG. 5, an example of how a microprocessor describes movements is shown. In this example, movements are split up into four characteristics, those being the length of the movement, the sector of the track the movement begins in, the sector of the track the movement ends in, and the current rank of that movement according to the scores allocated to it. FIG. 6 shows a number of examples of possible movements around an oval track.

It will be appreciated that a number of different shaped tracks can be described depending on the number and size of pulleys used in the body massager and that there may be a number of different ways to control movements of a massaging element about these tracks.

1. A body massager comprising:
a housing having a membrane attached thereto;
a ball moveably retained within a cup, the ball engaging with and moveable along an inner surface of the membrane; and
a drive means for driving the cup and ball across the inner surface of the membrane.

2. A body massager according to claim 1, wherein the drive means comprises a stepper motor.

3. A body massager according to claim 1, wherein the drive means comprises a DC motor.

4. A body massager according to claim 1, wherein the drive means comprises a belt attached to the cup.

5. A body massager according to claim 4, wherein the belt is arranged to be driven around at least two wheels.

6. A body massager according to claim 5, wherein the at least two wheels are of dissimilar diameter.

7. A body massager according to claim 1, wherein the drive means sits on a frame mounted on flexible mountings.

8. A body massager according to claim 1, further comprising means for vibrating the cup and ball.

9. A body massager according to claim 8, wherein the speed of vibration is selectable.

10. A body massager according to claim 8, wherein the means for vibration is provided by a DC motor attached to the frame and an eccentric mass attached to the shaft of said motor.

11. A body massager according to claim 1, wherein the speed and direction of motion provided by the drive means are selectable.

12. A body massager according to claim 9, wherein the means for vibration is provided by a DC motor attached to the frame and an eccentric mass attached to the shaft of said motor.

13. A body massager according to claim 2, wherein the drive means sits on a frame mounted on flexible mountings.

14. A body massager according to claim 13, wherein the drive means comprises a belt attached to the cup.

15. A body massager according to claim 14, wherein the belt is arranged to be driven around at least two wheels.

16. A body massager according to claim 15, wherein the at least two wheels are of dissimilar diameter.
